(19) United States
(12) Patent Application Publication
(10) Pub. No.: US 2023/0361365 A1
(43) Pub. Date: Nov. 9, 2023

(54) METHOD FOR THE GENERATOR BATTERY CHARGING PROCESS

(71) Applicant: Michael Lee Bivens, Chicago, IL (US)

(72) Inventor: Michael Lee Bivens, Chicago, IL (US)

(21) Appl. No.: 17/736,122

(22) Filed: May 4, 2022

(51) Int. Cl. H02J 50/10; H01M 10/44

(52) U.S. Cl. CPC H01M 10/44; H02J 50/10

(57) ABSTRACT

A recharging method using a Universal Motor, Generator, and a Copper Rechargeable Battery combined in a unique way. Most rechargeable batteries can be wrapped in copper and turned into a magnetic field for the recharging process.

### REFERENCES: (INCORPORATED HEREIN BY REFERENCE)

Mar. 25, 2009 — Provisional Patent Application: EFS ID: 5029073, Application Number: 61163039, Filer: Michael John Ries
May 05, 2014 - Provisional Patent Application: EFS ID:18949272, Application Number: 81988840, Filer: Michael John Ries
Nov. 19, 2020 - Copyright Registration Number: VAu1-412-493

### BACKGROUND OF THE INVENTION

The problem with all electric vehicles is that they have short mileage time before needing another charge at a Recharge Station. The recharge time ranges from 30 minutes or more slowing down progress to get to a far destination depending on what vehicle is being used. The Generator Battery has solved this problem by recharging the battery while driving which can be regulated for longer mileage time. Rechargeable batteries have a life expiration date so this is not an infinite energy source. It is designed to last until needing to be replaced. The Generator Battery is a Universal Brushless Motor, Generator, and a Copper Rechargeable Battery combined into one unit. This combination gives the Generator Battery more than one use and can be used in a wide range of electrical products. The same charging problem effects all electronics and the Generator Battery has solved this problem.

### BRIEF SUMMARY OF THE INVENTION

In one embodiment of the invention is a method for charging rechargeable batteries. This can be done in many versatile ways by combining a Universal Motor, Generator, and a Copper Rechargeable Battery in a unique way. Battery Powered Generators on the market today uses power from an outlet or solar panel to recharge the battery. The Generator Battery recharges itself after the first charge of the unit which makes it more versatile in any situation when it is needed. This recharging method makes it superior when it comes to running a generator when there is no gas or a working outlet in the area. A solar panel can also be used to charge the Generator Battery for the first time making it more versatile than the other generators on the market today.

### BRIEF DESCRIPTION OF THE DRAWINGS

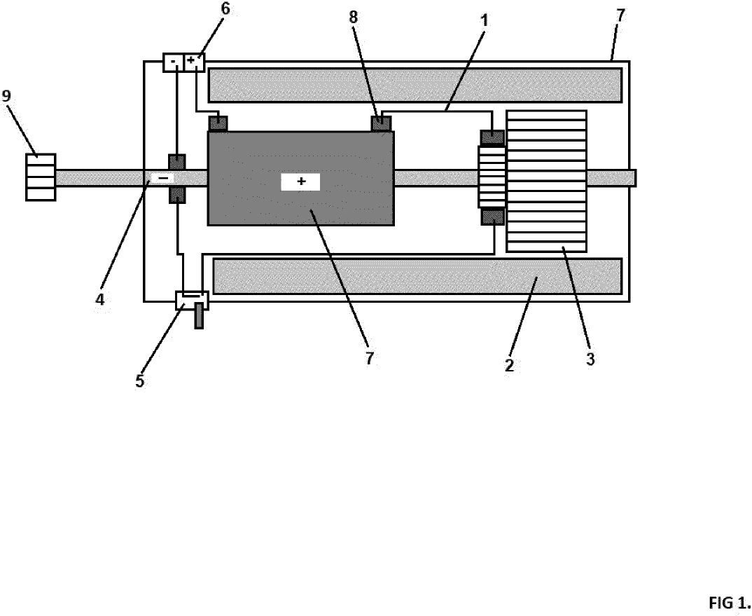

FIG. 1. Generator Battery
(1) Copper Wire
(2) Magnets
(3) Armature/Rotor
(4) Axle
(5) On/Off Switch
(6) Positive/Negative Terminal
(7) Shell
(8) Brushes
(9) Tooth Gear

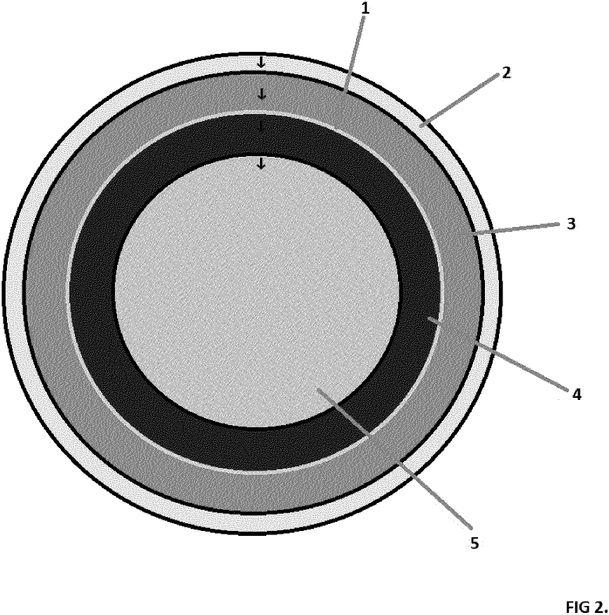

FIG. 2. Copper Lithium-Ion Battery
(1) Seperator Layer
(2) Positive Copper Layer
(3) Positive Electrode Cathode Layer
(4) Negative Electrode Anode Layer
(5) Negative Iron Bar

### DETAILED DESCRIPTION AND BEST MODE OF IMPLEMENTATION

In one embodiment of the invention is a method for charging rechargeable batteries. Most rechargeable batteries can be used as an embodiment for this method. The Generator Battery is a Universal Motor, Generator, and a Copper Rechargeable Battery combined in a unique way. A lithium-ion battery is wrapped in copper and is turned into a magnetic field by the motor. In one embodiment of the invention is one copper wrapped rechargeable battery in the unit that powers the motor which rotates the copper battery in between a magnetic field in the unit. The electricity made from the copper layer turning in a magnetic field, stores into the rechargeable components of the lithium-ion rechargeable battery. Extra generators can be added for extra power and a circuit breaker switch for safety. This invention can be made in all shapes, sizes, and the components can be rearranged and some added to make this product one of the most effective on the market.

1. A recharging method using a Universal Motor, Generator, and a Copper Rechargeable Battery combined in a unique way.

2. Rechargeable batteries of all kinds, wrapped in copper for the recharging process.
